(19) United States
(12) Patent Application Publication
(10) Pub. No.: US 2006/0060615 A1
(43) Pub. Date: Mar. 23, 2006

(54) Dispenser

(76) Inventor: Nigel Haig McLisky, Auckland (NZ)

Correspondence Address: Zaghmout;Bio Intellectual Property Services, 8509 Kernon Ct, Lorton, VA, 22079, US

(21) Appl. No.: 10/516,326

(22) PCT Filed: Jun. 10, 2003
(86) PCT No.: PCT/NZ03/00117

§ 371 Date: Jan. 21, 2005

(30) Foreign Application Priority Data
Jun. 11, 2002 (NZ) 519453

(51) Int. Cl. B67D 3/00

(52) U.S. Cl. 222/504

(57) ABSTRACT

According to the invention there is a dispenser (1), the dispenser having a dispenser head (2) and a container (3), containing spray material, the dispenser being formed such that the container (3) can be detached from the dispenser head (2) and refilled and/or replaced when the spray material is exhausted; the dispenser (1) having a solenoid valve means (4) substantially enclosed in a substantially metallic locking cover means, the valve means (4) being arranged to substantially facilitate movement of the spray material from the container (3) to the spray head (2), and the cover means being arranged to intensity a magnetic field which, when the dispenser is in use, facilitates opening and closing of the valve means. The dispenser (1) being formed such that in can be set so the valve means (4) opens and closes automatically and periodically to release a flow of spray material from the container to the spray head such that the spray material is released as a spray to an atmosphere outside of the dispenser.

### FIELD OF INVENTION

This invention relates to a dispenser. A preferred form of the invention relates to an dispenser for automatically releasing a spray into an atmosphere intermittently.

### BACKGROUND ART

It is known to use automatic aerosol dispensers to spray liquid agricultural chemicals, odor neutralizers, disinfectants, or essential oils, etc, into an atmosphere. In the case of agricultural chemicals these may be for the purpose of repelling or destroying insect pests. A problem with many of the existing dispensers is that they become ineffective at high temperatures. It is accordingly an object of at least one form of the present invention to go at lest some way towards addressing this problem, or to at least provide the public with a useful choice.

The term “comprise”, “comprises”, “comprised” or “comprising” if and when used in this document, should be interpreted non-exclusively, i.e. should be interpreted non-exclusively to mean “consisting of or including”.

### SUMMARY OF THE INVENTION

According to one aspect of this invention there is provided a dispenser, the dispenser having a dispenser head and a container containing spray material, the dispenser being formed such that the container can be detached from the dispenser head and refilled and/or replaced when the spray material is exhausted;

the dispenser having solenoid valve means substantially enclosed in a substantially metallic locking cover means, the valve means being arranged to substantially facilitate movement of the spray material from the container to the spray head, and the cover means being arranged to intensify a magnetic field which, when the dispenser is in use, facilitates opening and closing of the valve means;

the dispenser being formed such that it can be set so the valve means opens and closes automatically and periodically to release a flow of spray material from the container to the spray head such that spray material is released as a spray to an atmosphere outside of the dispenser.

The dispenser head may be at an upper or lower part of the dispenser.

Preferably the dispenser has a power source arranged to power opening and closing of the valve means.

Preferably the power source comprises a battery.

Preferably the dispenser comprises electronic means (eg a printed circuit board) arranged to control opening and closing of the valve means.

Preferably the electronic means is powered by the power source.

Preferably the container comprises an aerosol can.

Preferably the cover means comprises a first part and a second part, and wherein these two parts can lock with respect to one another.

Preferably the first and second parts can be subsequently released from one another when desired.

Preferably the first part comprises a hooked portion and the second part comprises an indented portion, the hooked and indented portions being complimentary to one another such that the hooked portion can engage the indented portion to lock the cover means.

Preferably the first part of the cover means can be clicked into engagement with the second part of the cover means.

Preferably the dispenser comprises a spray nozzle arranged to cause the spray material to form a spray as it leaves the dispenser.

### DESCRIPTION OF THE DRAWINGS

Some preferred aspects of the invention will now be described by way of example and with reference to the accompanying drawings, of which:

FIG. 1 is a schematic cross-sectional view of an automatic aerosol dispenser, and

FIG. 2 is a schematic cross-sectional view showing detail of part of the dispenser.

### DETAILED DESCRIPTION

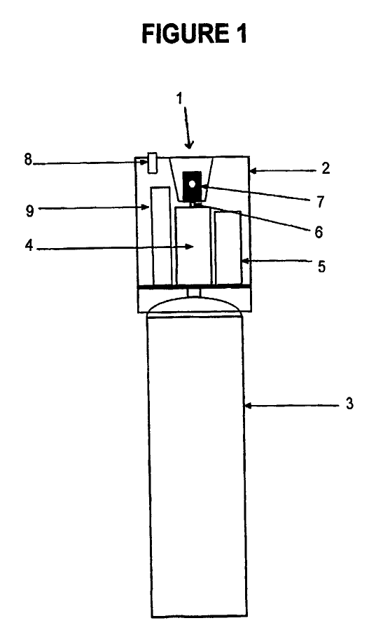

Referring to FIG. 1, the dispenser 1 comprises a dispenser head 2 and a container 3. The dispenser head 2 has a solenoid valve 4 which is powered by a small battery 5. When the valve 4 is opened it allows spray material to flow from the container 3 to be released to the atmosphere via an aperture 6 and a spray nozzle 7. The spray head 2 also has a switch 8 which can be used to activate a circuit board 9 for controlling opening and closing of the valve 4. The circuit board 9 is powered by the battery 5.

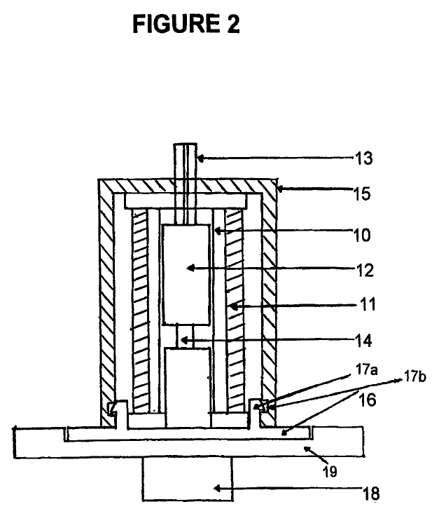

Referring to FIG. 2, the solenoid valve 4 comprises a bobbin 10 which is wound with electrical wire 11, through which an armature 12 is moveable. More particularly, the armature 12 can move when a magnetic flux is created within the bobbin 10 in response to an electrical current. It will be appreciated that when the armature 12 moves appropriately the valve 4 is momentarily opened. When the valve 4 is opened, pressurized fluid held in the container 3 is able to pass through the valve 4 to the atmosphere through a valve seat 13. When the electric current ceases the armature 12 is returned to its original position by a spring 20, thus closing the valve.

The valve 4 is enclosed in a metallic cover comprising a metallic hood 15 and a metallic base 16. The base 16 has a hooked portion 17a and the hood 15 has an indented portion 17b. The hooked and indented portions are complimentary to one another. The hooked portion 17a can be clipped or otherwise engaged with the indented portion 17b to lock the cover.

With further reference to FIG. 2, the base 16 comprises a fitting 18 which connects to the container 3, eg by way of a screw thread or some alternative means. Fluids in the container 3 may flow through the solenoid valve 4 via the fitting 18 when the valve is opened.

Preferably the invention is such that the metal cover enhances or intensifies the magnetic flux associated with the solenoid valve 4. By locking the cover as described above, the hood 15 and the base 16 are resistant to separation as a result of possible softening of plastic parts forming part of the dispenser—for example softening of the bracket 19 in which the base 16 rests (see FIG. 2). The locking facility for the cover also resists separation of the hood 15 and base 16 due to gas pressure within the dispenser head 2/valve 4. Those skilled in the art will appreciate that increased gas pressure may result from increases in temperature of the atmosphere surrounding the dispenser, and thus within the container.

It will be appreciated by those skilled in the art that if the hood 15 and the base 16 separate, for example as a consequence of rising temperatures, then the magnetic flux associated with the solenoid valve 4 may deteriorate. Indeed if the separation is too great then the valve 4 may not function properly, or may not function at all.

Preferably the dispenser 1 is such that it can be set to automatically and intermittently releaese a spray of the spray material within the container into the outside atmosphere. Once set, and if desired, the dispenser 1 can be left running until the spray material is exhausted. When the container 3 is exhausted it may be detached from the spray head 2, refilled, and then again attached to the spray head 2 for further use. Alternatively the container 3 may be replaced altogether. Preferably the dispenser head 2 can be used with containers of various sizes, or having different spray materials. Such containers are preferably of an aerosol type, although the invention can be used with alternative container types.

Preferably the dispenser 1 is formed such that it can function effectively at ambient temperatures of up to 75° C.

While some preferred forms of the invention have been described by way of example, it should be appreciated that improvements and modifications can occur without departing from the scope of the following claims.

1. A dispenser, the dispenser having a dispenser head and a container containing spray material, the dispenser being formed such that the container can be detached from the dispenser head and refilled and/or replaced when the spray material is exhausted;
the dispenser having solenoid valve means substantially enclosed in a substantially metallic locking cover means, the valve means being arranged to substantially facilitate movement of the spray material from the container to the spray head, and the cover means being arranged to intensify a magnetic field which, when the dispenser is in use, facilitates opening and closing of the valve means;
the dispenser being formed such that it can be set so the valve means opens and closes automatically and periodically to release a flow of spray material from the container to the spray head such that spray material is released as a spray to an atmosphere outside of the dispenser.

2. A dispenser according to claim 1, comprising a power source arranged to power opening and closing of the valve means.

3. A dispenser according to claim 1, comprising a power source arranged to power opening and closing of the valve means, wherein the power source comprises a battery.

4. A dispenser according to claim 1, comprising
a power source arranged to power opening and closing of the valve means, and comprising electronic means arranged to control opening and closing of the valve means.

5. A dispenser according to claim 1, comprising a power source arranged to power opening and closing of the valve means, and comprising electronic means arranged to control opening and closing of the valve means, wherein the electronic means is powered by the power source.

6. A dispenser according to claim 1, wherein the container comprises an aerosol can.

7. A dispenser according to claim 1, wherein the cover means comprises a first part and a second part, and wherein these two parts can lock with respect to one another.

8. A dispenser according to claim 1, wherein the cover means comprises a first part and a second part, and wherein these two parts can lock with respect to one another, and wherein the first and second parts can be subsequently released from one another when desired.

9. A dispenser according to claim 1, wherein the cover means comprises a first part and a second part, and wherein these two parts can lock with respect to one another, and wherein the first part comprises a hooked portion and the second part comprises an indented portion, the hooked and indented portions being complimentary to one another such that the hooked portion can engage the indented portion to lock the cover means.

10. A dispenser according to claim 1, wherein the cover means comprises a first part and a second part, and wherein these two parts can lock with respect to one another and wherein the first part comprises a hooked portion and the second part comprises an indented portion, the hooked and indented portions being complimentary to one another such that the hooked portion can engage the indented portion to lock the cover means, and wherein the first part of the cover means can be clicked into engagement with the second part of the cover means.

11. A dispenser according to claim 1, comprising a spray nozzle arranged to cause the spray material to form a spray as it leaves the dispenser.

12. (canceled)

13. A dispenser, the dispenser having a dispenser head and a container containing spray material, the dispenser being formed such that the container can be detached from the dispenser head and refilled and/or replaced when the spray material is exhausted
the dispenser having a solenoid valve means substantially enclosed in a substantially metallic locking cover means, the dispenser having a power source arranged to power opening and closing of the valve means, and the dispenser having electronic means arranged to control opening and closing of the valve means;
the locking cover means having a hooked portion and an indented portion complimentary to one another such that the hooked portion can engage the indented portion to lock the cover means, the valve means being arranged to substantially facilitate movement of the spray material from the container to the spray head, and the cover means being arranged to intensify a magnetic field which, when the dispenser is in use, facilitates opening and closing of the valve means;
the dispenser being formed such that it can be set so the valve means opens and closes automatically and periodically to release a flow of spray material from the container to the spray head such that spray material is released as a spray to an atmosphere outside of the dispenser.

14. A dispenser according to claim 13, wherein the power source comprises a battery.

15. A dispenser according to claim 13, wherein the container comprises an aerosol can.
